(19) United States
(12) Patent Application Publication
(10) Pub. No.: US 2004/0221875 A1
(43) Pub. Date: Nov. 11, 2004

(54) Cleaning method

(76) Inventors: Koichiro Saga, Kanagawa (JP); Hiroya Watanabe, Tokyo (JP); Tomoyuki Azuma, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/776,891

(22) Filed: Feb. 11, 2004

(30) Foreign Application Priority Data
Feb. 19, 2003 (JP) P2003-040865

(51) Int. Cl. B08B 3/00

(52) U.S. Cl. 134/26; 510/175

(57) ABSTRACT

Method of using a supercritical fluid to clean a substrate having a fine structure in which a cleaning process is carried out by immersing the substrate in supercritical carbon dioxide for a predetermined time, and foreign matter adhering to the substrate is removed. After this, a rinsing process is performed on the substrate by stopping the supplying of a tertiary amine compound and supplying only the supercritical carbon dioxide so that the supercritical carbon dioxide to which the tertiary amine compound has been added is replaced with pure supercritical carbon dioxide. Next, the supplying of the carbon dioxide is stopped and the supercritical carbon dioxide inside the processing chamber is discharged so that the temperature and pressure inside the processing chamber fall, resulting in the carbon dioxide inside the processing chamber being gasified and the substrate being supercritically dried.

### BACKGROUND OF THE INVENTION

1. Field of the Invention

The present invention relates to a method of cleaning a substrate having a fine structure using a supercritical fluid. In more detail, the present invention relates to a method of cleaning a substrate in a simple process using a supercritical fluid without damaging the fine structure of the substrate, and in particular to an optimal method for cleaning a substrate having an electrode pattern or the like with a high aspect ratio or a fine structure composed of gaps, hollows, and pores during the manufacturing of a semiconductor device, a micromachine, or the like.

2. Description of the Related Art

Together with the increases in scale and integration of semiconductor devices in recent years, many advances have been made in the miniaturization of electrode structures. In the manufacturing of LSIs, trace widths are reaching 100 nm and below, and inevitably patterns with a high aspect ratio (high/width) for wiring and the like are being formed by carrying out a pattern etching of a material film on a substrate.

In the pattern etching process, as one example, a resist film is formed on a material film formed on the substrate, the resist film is then patterned to form a resist mask with a predetermined pattern. Next, the resist mask is used as an etching mask and the material film is etched.

Accordingly, as the aspect ratio of the pattern formed by the pattern etching increases, the aspect ratio of the resist pattern inevitably increases.

### Chemical Cleaning After a Pattern Etching

Normally, when this kind of pattern formation is carried out, after a resist mask removing process is carried out following the pattern etching process, a series of wet-type cleaning processes, such as a chemical cleaning using a chemical liquid and a rinsing using a rinsing liquid such as pure water, and a drying process are carried out on the material film on the substrate to remove minute foreign bodies, such as etching residue, remaining between the patterns in the patterned material film.

In the same way, in the formation process for the resist pattern, a wet-type cleaning process and a drying process are carried out after the resist pattern has been formed by developing.

### Problem of Chemical Cleaning

However, when the drying process is carried out during the cleaning of a minute pattern, differences in pressure between the chemical liquid or rinse liquid remaining in gaps in the pattern and the surrounding atmosphere often cause the resist pattern formed on the substrate layer or the pattern itself formed by the pattern etching to become flattened.

As the rinse liquid used in the rinsing and a liquid such as a drying liquid used in the drying process are evaporated from gaps in the pattern formed in the material film and gaps in the resist pattern (hereinafter, when not stated otherwise such patterns are referred to in general as “patterns”) that have a high aspect ratio, the volume of the liquid remaining in the gaps in the patterns is reduced. Surface tension is produced in the liquids and since a pulling force is exerted on the pattern, parts of the pattern become flattened.

The magnitude of the pulling forced exerted on the pattern depends on the surface tension produced at the gas-liquid interfaces in the gaps in the pattern, and for a pattern with a high aspect ratio, the pulling forces are considerably larger. In addition, the pulling forces have sufficient force not just to flatten the resist pattern but also to bend the pattern of the foundation layer of the resist pattern, so that the surface tension of the rinse liquid or the drying liquid that produces the pulling force is an important factor when selecting the rinse liquid or the drying liquid.

### Chemical Cleaning When Manufacturing Micromachine

A phenomenon resembling the pattern flattening during pattern etching that happens during the manufacturing process of a semiconductor device also occurs during the manufacturing process for a minute moving element called a micromachine.

First, the structure of a GLV device that is constructed of a micromachine will be described with reference to FIGS. 3A and 3B. FIG. 3A is a perspective view showing the structure of the GLV device, while FIG. 3B is a cross-sectional view taken along a line I-I in FIG. 3A.

As shown in FIG. 3A, the GLV device 70 is a device in which a plurality of micromachines 72 are densely arranged in parallel on a common substrate 78.

The micromachines 72 that compose the GLV device are movable elements equipped with electrostatically driven bridges 76 having a light reflecting surface 74 on an upper surface. The bridges 76 are mechanically moved by electrostatic attraction or electrostatic repulsion, and by adjusting a distance between the light reflecting surface 74 and the substrate 78, it is possible to modulate the intensity of the reflected light that is reflected.

As shown in FIG. 3B, the micromachines 72 are equipped with an insulating substrate 78 that is a glass substrate or the like, a substrate-side electrode 80 that is formed on the insulating substrate 78 as a Cr thin film or the like, and the electrostatically driven bridges 76 that perpendicularly span the substrate-side electrode 80 in the form of bridges and are perpendicular to the substrate-side electrode 80.

The electrostatically driven bridges 76 and the substrate-side electrode 80 are electrically insulated from one another by gap parts 82 between them.

The electrostatically driven bridges 76 are based on the insulating substrate 78 so as to span the substrate-side electrode 80 in the form of bridges, and are each comprised of a membrane 84 made up of an SiN film, a polysilicon film, and the like provided as an electrode support member, and a light reflecting film/membrane-side electrode 86 provided on the membrane 84 alternately in parallel with one another and facing the substrate-side electrode 80.

The membranes 84 face the substrate-side electrode 80 and are separated by a predetermined gap so as to provide the gap part 82, and are provided alternately in parallel with one another with respect to the substrate-side electrode 80 in order to support the light reflecting film/membrane-side electrodes 86.

In the GLV device 70, as shown in FIG. 3A, the insulating substrate 78 and the substrate-side electrode 80 are a common substrate and a common electrode for the respective micromachines 72.

When a minute voltage is applied between the substrate-side electrode 80 and the light reflecting film/membrane-side electrodes 86 that face the substrate-side electrode 80, an electrostatic phenomenon causes the electrostatically driven bridges 76 to approach the substrate-side electrode 80, and when the application of the voltage is stopped, the bridges are separated and return to the original states.

In the micromachines 72 composing the GLV device 70, the operation whereby the electrostatically driven bridges 76 approach and move away from the substrate-side electrode 80 changes the orientation of the light reflecting film/membrane-side electrodes 86 and therefore modulates the intensity of the reflected light, so that the micromachines 72 can function as light modulating elements.

The hollow structure for required for the bridges 76 to function as moving bodies is formed by forming, between the membrane 84 and the substrate-side electrode 80, a sacrificial layer that is ultimately removed, and selectively removing only the sacrificial layer after the bridges 76 have been formed.

Next, the method of manufacturing the micromachines 72 will be described with reference to FIGS. 4A to 4D and FIGS. 5A and 5B. FIGS. 4A to 4D and FIGS. 5A and 5B are cross-sectional views for respective processes when manufacturing the micromachines 72, with FIGS. 4(a) to (d) being cross-sectional views corresponding to a cross-section taken along a line II-II in FIG. 3A and FIGS. 5A and 5B being cross-sectional views taken along a line I-I in FIG. 3A.

First, as shown in FIG. 4A and FIG. 5A, a metal film, such as a tungsten film, is formed on the substrate 78, the metal film is patterned to form the substrate-side electrode 80, an amorphous silicon film or a polysilicon film is then formed on an entire surface of the substrate 78, and this film is then patterned to form a sacrificial layer 88 on the substrate-side electrode 80.

The sacrificial layer 88 functions as a support layer for forming the membrane 84 next and as described later, is ultimately removed. For this reason, the sacrificial layer 88 is formed of an amorphous silicon film, a polysilicon film, or the like that has a high etching selection ratio compared to an oxide layer, a nitride layer and a metal layer forming the substrate-side electrode 80 and the membrane-side electrodes 86. For example, when a silicon substrate is used as the substrate 78, SiO₂, PSG (PhosphoSilicate Glass) or the like is used, while when an SiO₂ substrate is used as the substrate 78, a polysilicon film is used.

Next, an SiN layer is formed on the entire surface of the substrate 78, the SiN layer is patterned, and the membrane 84 is formed so as to contact the sacrificial layer 88 and to be based on the insulating substrate 78 and span the sacrificial layer 88.

Also, a membrane-side electrode film composed of an aluminum film is formed on the entire surface of the substrate 78 including the membrane 84, and the membrane-side electrodes 86 are formed on the membrane 84 by patterning.

Next, as shown in FIG. 4B, a resist film is formed on the light reflecting film/membrane-side electrodes 86, and after this, a striped etching mask 90 is formed.

After this, as shown in FIG. 4C, the laminated structure is etched as far as the substrate-side electrode 80 using the etching mask 90, thereby fabricating the striped laminated structure that forms the individual micromachines.

Next, as shown in FIG. 4D and. FIG. 5B, the sacrificial layer 88 is removed by dry etching using XeF₂ gas or the like. By forming the bridges 76 composed of the membrane 84 and the light reflecting film/membrane-side electrodes 86 that cross over the substrate-side electrode 80 with the gap part 82 in between, the micromachines 72 are manufactured.

However, when an etching process that etches the laminated structure on the substrate 78 to produce the striped laminated structure 92, as shown in FIG. 6A, etching residue A is produced on both sides of the striped laminated structure 92 and on the substrate-side electrode 80.

For this reason, after the etching process has been completed, in the same way as the cleaning that follows the pattern etching process in the method of manufacturing a semiconductor device described above, chemical cleaning using a chemical liquid, rinsing using a rinsing water, and a drying process are carried out and the etching residue remaining on both sides of the laminated structure 92 and on the substrate-side electrode 80 are removed.

However, when a conventional cleaning is carried out, as shown in FIG. 6B, there are many cases where the etching residue remaining on both sides of the laminated structure 92 and on the substrate-side electrode 80 is not removed and remains.

Also, when the sacrificial layer 88 has been removed by etching according to a dry etching method, as shown in FIG. 6C, etching residue A remains on both sides of the bridge 76 and on the substrate-side electrode 80. As shown in FIG. 6B, there are also effects due to the etching residue that remains on both sides of the laminated structures 92.

For this reason, chemical cleaning using a chemical liquid, rinsing using rinsing water, and a drying process are performed in the same way.

### Problem of Chemical Cleaning When Manufacturing Micromachine

However, when cleaning is performed after the gap parts 82 have been formed by selective etching to remove the sacrificial layer 88, if a wet-type cleaning process and drying process, such as those used in a normal manufacturing process for a semiconductor device, are carried out, pulling forces produced due to the surface tension described above are exerted on the bridges 76 and in many cases the bridges 76 get stuck to the substrate 78 or become damaged.

For this reason, in conventional methods of manufacturing micromachines, after the etching of the sacrificial layer 88, the following process is often carried out instead of the cleaning process.

However, when doing so etching residue causes problems such as a reduction in the manufacturing yield of micromachines, a lowering of reliability, and deterioration in the element characteristics.

### Conventional Cleaning by Supercritical Fluid

As described above, during the cleaning of micromachines or other microstructures with moving parts and during the cleaning of a substrate after pattern etching that does not include moving parts, the extent of the damage to the microstructures is affected by the magnitude of the surface tension of the cleaning liquid.

To prevent damage due to such surface tension, it is thought possible to perform the cleaning and drying using a fluid that has a lower surface tension than water, such as methanol that has a surface tension of around 23 dyn/cm as compared to water that has a surface tension of around 72 dyn/cm.

Compared to drying after water has been used, drying after replacement of the water with methanol can suppress damage to the pattern due to moving parts such as the bridges sticking, but since methanol still has a considerable surface tension, it is not possible to effectively resolve the problems such as damage to the moving parts and flattening of the pattern.

In order to resolve problems such as pattern flattening due to the surface tension, it is possible to use a liquid with a surface tension of zero as the cleaning liquid and rinsing liquid, or to perform the drying after a normal rinsing liquid used for the rinsing has been replaced with a fluid with a surface tension of zero.

A fluid with zero surface tension is a fluid in a supercritical state, that is, a supercritical fluid, with “supercritical” referring to one phase assumed by a substance at conditions that are equal to or above a critical temperature and a critical pressure that are unique for the substance. In a supercritical state, even though the dissolving power for other fluids and solids is approximately equal to the dissolving power of the substance in a liquid state, the substance has exceptional properties in that the viscosity is extremely low and the diffusion coefficient is extremely high, so that a supercritical fluid can be said to be a liquid in a gas-like state.

A supercritical fluid does not form a gas-liquid interface, so that the surface tension is zero. Accordingly, if drying is performed with a substance in a supercritical state where there is no surface tension, there will be no pattern flattening whatsoever.

Gasification of a supercritical fluid occurs rapidly when the ambient pressure falls to the critical pressure or below, so that drying after cleaning with a supercritical fluid is easy since it is sufficient to release the fluid from the supercritical state so that the pressure falls and the fluid is gasified.

For example, when using a supercritical fluid to clean a substrate which may be micromachines from which the sacrificial layer has been removed by etching or a substrate on which a fine pattern with a high aspect ratio has been formed, substrates that are immersed in the cleaning liquid are directly brought into contact with a supercritical fluid held in a pressure-resistant vessel, resulting in the etching liquid that adheres to the substrates being dissolved in the supercritical fluid, so that the etching residue can be removed together with the etching liquid.

Also, after the etching has been performed, when a cleaning process has been performed using a cleaning liquid and the substrates immersed in the cleaning liquid have been subjected to a rinsing process using another liquid, such as a rinsing liquid, the substrates immersed in the rinsing liquid are brought into direct contact with the supercritical fluid.

Also, as an alternative method, in a state where a substrate, for example, a wafer for which pattern etching has been completed, is soaked in an etching liquid used for wet etching, the etching fluid is replaced with a substance that is capable of becoming a supercritical fluid (hereinafter referred to as a “supercritical substance”). Next, by adjusting the pressure and the temperature in the system in which the wafer is held, it is possible to convert the supercritical substance directly into a supercritical fluid without gasifying the substance and to clean the wafer with the supercritical fluid. Next, the pressure is reduced, and the supercritical fluid is gasified and released.

By carrying out the above steps, the fine structures of the substrates are dried without being exposed to a gas-liquid interface, so that there is no flattening of the patterns due to the surface tension of the cleaning liquid, rinsing liquid and the like. During the cleaning process for micromachines also, destruction of the gap part is avoided (see Japanese Laid-Open Patent Publications No. 2000-91180 and No. H09-139374).

It should be noted that supercritical fluid replaces the rinsing liquid in a case where cleaning is performed after etching and the cleaning liquid is replaced with rinsing liquid, or another liquid in a case where the rinse liquid is replaced with another liquid.

Next, the temperature of the pressure-resistant vessel in which the supercritical fluid is held is kept at equal to or above the critical temperature, and the pressure inside the pressure-resistant vessel is reduced to or below the critical pressure, so that the supercritical fluid is gasified and released, before the substrate is taken out into the atmosphere.

Since the surface tension of the supercritical fluid is extremely low, when the supercritical fluid becomes detached from the surfaces of the fine structure of the substrate, the stress applied to the fine structure by the surface tension of the supercritical fluid is of a negligible level. Accordingly, during cleaning, the supercritical fluid does not cause any damage to the fine structure.

That is, by using a supercritical fluid as a cleaning liquid during the manufacturing of an object having a fine structure, it is possible to effectively remove the cleaning liquid and the like that adheres during an etching process without causing deformation or damage to the fine structure.

As the supercritical substance used for such cleaning, many substances, such as carbon dioxide, nitrogen, ammonia, water, alcohols, an aliphatic saturated hydrocarbon with a low molecular weight, benzene, and diethyl ether, have been confirmed as becoming supercritical fluids.

Out of such supercritical substances, carbon dioxide whose critical temperature of 31.3° C. is close to room temperature is one example of a substance that can be favorably used in the cleaning process since it is easy to handle and does not require the substrate to be exposed to a high temperature.

However, carbon dioxide that is normally used as a supercritical fluid has a property whereby it becomes a non-polar solvent in the supercritical fluid state, so that selectivity occurs for the dissolving power of the carbon dioxide of the supercritical fluid (hereinafter referred to as “supercritical carbon dioxide”).

The supercritical carbon dioxide can remove organic substances with low molecular weights, such as resist that has not been exposed to light, but is not always effective at removing polymerized organic substances such as etching residue, or pollutants such as inorganic mixed compounds, and at removing oxide films.

For this reason, before drying is performed using supercritical carbon dioxide, it is conventional to carry out a wet-type cleaning using a chemical liquid that has conventionally been found to have superior dissolving power and oxide resolving power. For example, to prevent damage caused by surface tension at gas-liquid interfaces, after the substrate has been cleaned, the substrate is transferred from the cleaning liquid to a rinsing liquid without being exposed to gas, and then the rinsing liquid is directly replaced with the supercritical carbon dioxide without being dried (see Japanese Laid-Open Patent Publication No. 2001-165568).

When the object is to remove the resist residue, a method that dissolves an organic amine compound in the fine structure of the substrate and after this removes the organic amine compound using supercritical carbon dioxide has been proposed (see Japanese Laid-Open Patent Publication No. H10-260537, FIG. 1).

Here, an organic amine compound is an organic compound in which an alkyl group, a functional group, an aryl group or other functional group has been substituted for one or more of the hydrogen atoms in ammonia.

### Patent Document 1

Japanese Laid-Open Patent Publication No. H10-260537 (FIG. 1)

However, the cleaning methods described in the above patent publications that use a supercritical fluid have the following problem.

That is, the organic amine compound disclosed in the claims reacts with the supercritical carbon dioxide and therefore does not exert the effects of a dissolution auxiliary agent. As a result, a cleaning effect is not obtained. Although, the carbon dioxide commonly used as a supercritical fluid is extremely inactive and is hardly reactive at normal temperature and normal pressure, when a primary amine and a secondary amine is used as the organic amine compound, the carbon dioxide in the supercritical fluid state reacts with the primary amine and the secondary amine. As a result, not only does the organic amine compound fail to produce a cleaning effect for pollutants, other problems are caused such as the cleaning tank or pipes attached thereto becoming blocked with solid products of the reaction.

As described above, conventional cleaning methods that use supercritical fluids have not always been satisfactory.

### SUMMARY OF THE INVENTION

For the reasons given above, it is an object of the present invention to provide a method that can achieve effective cleaning performance for a substrate having a fine structure in a simple process using a supercritical fluid.

When an organic amine substance is used as a dissolution auxiliary agent, the problems that occur are caused by carbon dioxide molecules penetrating the N-H bonds of a primary amine and a secondary amine to produce carboxylic acid.

The idea of using a tertiary amine compound that does not have an N-D bond as the dissolution auxiliary agent occurred to the present inventors, and the present invention was realized by discovering through experimentation that the generation of carboxylic acid does not occur due to the penetration of carbon dioxide if a tertiary amine compound is used as the dissolution auxiliary agent.

In order to achieve the above object, a method of cleaning according to the present invention (hereinafter referred to as a “first method of the invention”) is a method of cleaning a substrate having a fine structure using a supercritical fluid, including a cleaning step that uses a supercritical fluid to which a predetermined amount of a tertiary amine compound has been added as a cleaning liquid and cleanes the substrate by having the substrate contact the supercritical fluid to which the tertiary amine compound has been added.

In a preferred embodiment of the method of the present invention, during the cleaning step, a substance that is in a gaseous state at ordinary temperature and normal pressure is subjected to a phase change to convert the substance into a supercritical fluid which is used as the cleaning liquid, the substrate is made to contact with the substance in a gaseous state, and then a phase change is effected to convert the substance in a gaseous state contacting the substrate directly into a supercritical fluid without passing a liquid state.

By doing so, the substrate does not contact a gas-liquid interface and so is not damaged by surface tension.

In a preferred embodiment of the method of the present invention, the method includes, following the cleaning step, a drying step of drying the substrate by directly gasifying the supercritical fluid in contact with the substrate without liquefying the supercritical fluid.

In a preferred embodiment of the method of the present invention, the method includes, following the cleaning step, a rinsing step of rinsing the substrate by supplying only the supercritical fluid and a drying step of subsequently drying the substrate by directly gasifying the supercritical fluid in contact with the substrate without liquefying the supercritical fluid.

Another method of cleaning according to the present invention (hereinafter referred to as a “second method of the invention”) is a method of cleaning a substrate having a fine structure using a supercritical fluid, including: a cleaning step of cleaning the substrate using a single tank-type cleaning/drying apparatus having a single tank cleaning/drying chamber by supplying the supercritical fluid, to which a predetermined amount of tertiary amine compound has been added, to the cleaning/drying chamber in which the substrate is held; a rinsing step of subsequently rinsing the substrate while replacing the supercritical fluid to which the tertiary amine compound has been added by supplying only the supercritical fluid to the cleaning/drying chamber; and a drying step of subsequently drying the substrate by removing the supercritical fluid in contact with the substrate by directly gasifying the supercritical fluid without liquefying the supercritical fluid, wherein the cleaning step and the drying step are carried out successively in the single tank cleaning/drying chamber.

In the first and second methods of the invention, more specifically the tertiary amine compound may be an aliphatic amine having at least one substituent group selected from an alkyl group, a hydroxyalkyl group, and an alkoxyalkyl group.

Alternatively, the tertiary amine compound may be an aromatic amine having at least one substituent group selected from an aryl group and an aralkyl group.

Also, the tertiary amine compound may be a heterocyclic amine.

Specific examples of the tertiary amine compounds that can be used in the first and second methods are given below.

As specific examples of the tertiary amine compound, aliphatic amines including at least one of an alkyl group, a hydroxyalkyl group, and an alkoxyalkyl group as a substituent group include, for example, trimethylamine, triethylamine, tripropylamine, tri-n-butylamine, tri-isobutylamine, tri-n-pentylamine, tri-isoamylamine, tri-n-hexylamine, tri-n-heptyl amine, tri-n-octylamine, tri(2-ethylhexyl) amine, tri-n-decyl amine, tri-n-dodecylamine, N,N,N′,N′-tetramethyl diaminomethane, N,N,N′,N′-tetramethylethylenediamine, N,N,N′,N′-tetramethyl-1,2-propane diamine, N,N,N′,N′-tetramethyl-1,3-propanediamine, N,N,N′,N″,N″-pentamethyl diethylenetriamine, N,N-dimethyl ethylamine, N,N-dimethyl isopropylamine, N,N-dimethyl-n-butyl amine, N,N-dimethyl-n-octylamine, N,N-dimethyl-n-decyl amine, N,N-dimethyl-n-dodecylamine, N,N-dimethyl-n-tetradecylamine, N,N-dimethyl-n-hexadecylamine, N,N-dimethyl-n-octadecylamine, N,N-dimethylcyclohexylamine, N,N-diethylcyclohexylamine, triethanolamine, triisopropanolamine, N-methyldiethanolamine, N-ethyl diethanolamine, N-n-butyl diethanolamine, N,N-dimethylethanolamine, N,N-diethyl ethanolamine, N,N-di-n-butyl ethanolamine, N,N-dimethyl-n-propanolamine, N,N-dimethyl-iso-propanolamine, tris(2-(2-methoxyethoxy)ethyl) amine, N,N-dimethyl hydroxyl amine, and N,N-diethylhydroxylamine.

Examples of aromatic amines including at least one of an aryl group and a aralkyl group as a substituent group include N,N-dimethylaniline, N,N-diethylaniline, N,N-dimethyl toluidine, N,N-diethyl toluidine, N,N-dimethylbenzylamine, N,N-diethyl benzylamine, and N,N-dibenzyl hydroxyl amine.

Additionally, examples of hetrocyclic amines include N-methylpyrrolidine, N-ethylpyrrolidine, N-methylpiperidine, N-ethylpiperidine, N,N′-dimethylpiperazine, N-methylmorpholine, N-ethyl morpholine, N-methylpyrrole, N-ethyl pyrrole, N-(2-hydroxyethyl) pyrrolidine, N-(2-hydroxyethyl) piperidine, N-(2-hydroxyethyl) morpholine, N-(2-hydroxyethyl) pyrrole, 1,5-diazabicyclo[4.3.0]-5-nonane, 1,4-diazabicyclo[2.2.2]octane, and 1,8-diazabicyclo[5.4.7]-7-undecane.

In the first and second methods of the invention, when a tertiary amine compound is used, specific examples of the dissolution auxiliary agent can be added to the supercritical substance singly or in combination. Also, the dissolution auxiliary agent and the supercritical substance do not need to be mixed evenly in every case.

However, in a case where the tertiary amine compound is evenly dissolved at arbitrary temperature and pressure conditions at or above the critical point, the total amount of tertiary amine compound added to the supercritical substance is a concentration of 0.1 mol % or above in the supercritical substance (supercritical fluid) in a case where the supercritical substance is carbon dioxide. When the concentration of the dissolution auxiliary agent is below this minimum concentration, it is difficult to remove polymerized etching residue.

The dissolution auxiliary agent normally has a higher critical temperature and a higher critical pressure than a supercritical substance such as carbon dioxide. Accordingly, since a mixed fluid of the supercritical substance and the dissolution auxiliary agent has a higher critical temperature and a higher critical pressure than the supercritical substance alone, it is preferable for 40° C. or above and 10 MPa or above, which are higher than the critical pressure and critical temperature of the supercritical fluid in the case where carbon dioxide is used of the supercritical fluid, to be maintained so that the dissolution auxiliary agent can favorably dissolve in the supercritical substance.

In the first and second methods of the present invention, by adding a tertiary amine compound to a supercritical fluid that has superior permeability, it is possible to supply the dissolution auxiliary agent to gaps in the fine structure of the substrates together with the supercritical fluid. Such dissolution auxiliary agent has a high cleaning performance for the material to be cleaned off the substrates, and therefore for reacts with, dissolves and removes etching residue that has been polymerized and resist residue after etching (hereinafter simply referred to as “residue”), for example.

By doing so, it is possible improve the cleaning performance whereby the material to be cleaned off the substrate, such as residue on the substrate after the formation of a fine structure by etching, is cleaned off and removed by a supercritical fluid.

Additionally, since the supercritical fluid is denser than air, the removed residue can be easily separated and cleaned away from the fine structure together with the chemical liquid and the supercritical fluid. Accordingly, residue can be reliably removed from gaps in a fine structure without carrying out a conventional wet-type cleaning.

In the first and second methods of the present invention, carbon dioxide, which becomes a supercritical fluid at close to normal temperature, should preferably be used as the supercritical fluid. However, aside from supercritical carbon dioxide, nitrogen, toluene, an aliphatic saturated hydrocarbon with a low molecular weight, benzene, and the like can be used as a non-polar supercritical fluid in the first and second methods of the present invention.

Also, in the first and second methods of the present invention, in order to improve the solving power of the dissolution auxiliary agent for the supercritical fluid, it is preferable to add another tertiary amine compound or an organic solvent together with dissolution auxiliary agent to the supercritical fluid.

### BRIEF DESCRIPTION OF THE DRAWINGS

The above and other objects, features, and advantages of the invention will become more apparent from the following detailed description taken in conjunction with the accompanying drawings.

In the drawings:

FIG. 1 is a schematic diagram showing a construction of a cleaning apparatus used when implementing a method according to a first embodiment of the present invention;

FIGS. 2A to 2C are cross-sectional views for respective processes that form an electrode structure;

FIGS. 3A is a perspective view showing a construction of a GLV device and FIG. 3B is a cross-sectional views showing a construction of a micromachine taken along a line I-I in FIG. 3A;

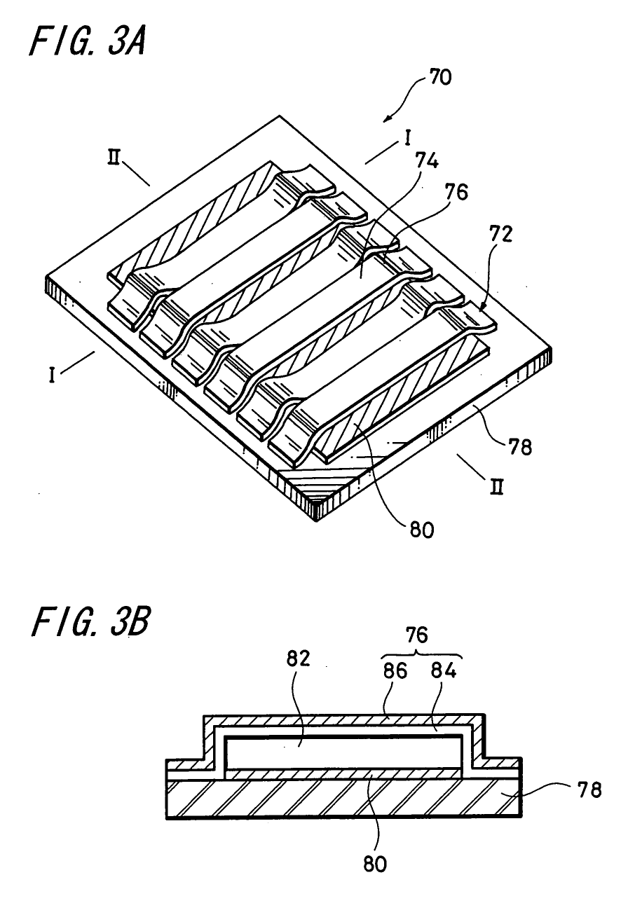

FIGS. 4A to 4D are cross-sectional views showing steps for manufacturing a micromachine, and correspond to cross-sections taken along a line II-II in FIG. 3A;

FIGS. 5A and 5B are cross-sectional views showing steps for manufacturing a micromachine, and correspond to cross-sections taken along a line I-I in FIG. 3A; and

FIGS. 6A to 6C are cross-sectional views showing a state where etching residue adheres during a manufacturing process of micromachines.

### DESCRIPTION OF THE PREFERRED EMBODIMENTS

The present invention will now be described in detail with reference to the accompanying drawings showing preferred embodiments thereof.

### First Exemplified Embodiment

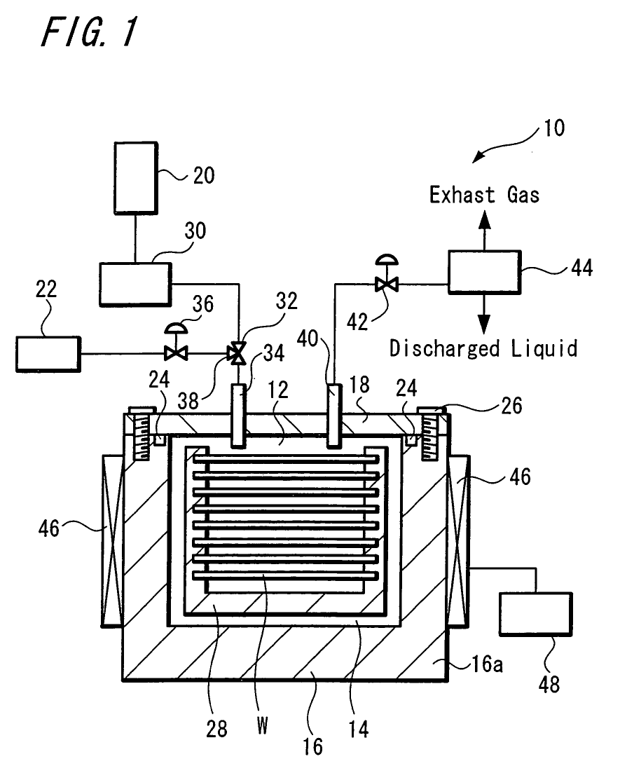

This embodiment is one example of implementing a cleaning method according to the present invention. FIG. 1 is a schematic diagram showing a construction of a cleaning/drying apparatus used when implementing the present embodiment.

First, the cleaning/drying apparatus used when implementing the method of the present embodiment will be described with reference to FIG. 1. A cleaning/drying apparatus 10 is a batch-type cleaning/drying apparatus that carries out a cleaning/drying process by holding a plurality of fine structures W like those described above as substrates in a cassette.

As shown in FIG. 1, the cleaning/drying apparatus 10 is comprised of a chamber 16 that includes an opening 12 in an upper part and a processing chamber 14 on an inside to hold the substrates W that have been introduced via the opening 12, a cap 18 that tightly closes the opening 12, a fluid supplying source 20 that supplies a processing fluid to the processing chamber 14, a fluid supplying means that introduces the processing fluid from the fluid supplying source 20 into the processing chamber 14 a tertiary amine compound supplying source 22 that supplies a tertiary amine compound to the processing fluid, a tertiary amine compound supplying means that adds the tertiary amine compound from the tertiary amine compound supplying source 22 to the processing fluid, and a fluid discharging means that discharges the processing fluid that was supplied to process the substrates from the processing chamber 14.

The expression “processing fluid” refers to a supercritical fluid used as a cleaning liquid that removes etching residue from the substrates or a rinsing liquid. It should be noted that a supercritical fluid to which tertiary amine compound has been added is also referred to as the “processing fluid”. However, as described later, before the cleaning process starts, when etching has been performed in the processing chamber 14 according to wet etching, the processing fluid of the etching process is the etchant. In the present embodiment, supercritical carbon dioxide is used as the supercritical fluid.

The substrates W are introduced and removed from the processing chamber 14 via the opening 12. An O ring 24 is arranged as a sealing member between an opening rim of the opening 12 of the processing chamber 14 and the cap 18 so that the opening 12 can be tightly closed by the cap 18. The cap 18 is attached to the processing chamber 14 by a tightening means 26 such as a screw thread, so that the processing chamber 14 is tightly closed. That is, by tightly attaching the cap 18 via the O ring 24 using the tightening means 26, it is possible to completely close off the inside of the processing chamber 14.

Additionally, on the inside of the processing chamber 14, it is possible to dispose a substrate holding cassette 28 for mounting and holding a plurality of the substrates W.

The fluid supplying means is comprised of a pressure/temperature controlling means 30 that controls the processing fluid so as to become a predetermined pressure and a predetermined temperature, a three-way valve 32, and a fluid supply port 34 provided on the processing chamber 14. This fluid supplying means introduces the processing fluid, whose pressure and temperature are controlled by the pressure/temperature controlling means 30 so as to be predetermined values, from the fluid supplying source 20 into the processing chamber 14 via the three-way valve 32 and the fluid supply port 34.

The tertiary amine compound supplying means supplies the tertiary amine compound from the tertiary amine compound supplying source 22 via a flow regulating valve 36 to a supply opening 38 of the three-way valve 32, and adds a predetermined amount of the tertiary amine compound to the processing fluid that enters the processing chamber 14 by adjusting a valve position of the flow regulating valve 36.

The fluid discharging means is comprised of a fluid discharge port 40 provided on the processing chamber 14, a discharge valve 42, and a discharged liquid separating apparatus 44 connected to the fluid discharge port 40 via the discharge valve 42.

The discharge valve 42 functions so as to open when the pressure inside the processing chamber 14 is at a set pressure or above and to discharge the processing fluid that has been introduced into the processing chamber 14. That is the discharge valve 42 can keep the pressure inside the processing chamber 14 at a predetermined pressure.

The discharged liquid separating apparatus 44 is a gas-liquid separating apparatus and separates a liquid component and a gas component of the discharged supercritical carbon dioxide including the tertiary amine compound by lowering the pressure to atmospheric pressure. The gas component is gasified supercritical carbon dioxide, and is collected by a gas collection apparatus (not shown) as exhaust gas. The liquid component is the tertiary amine compound and the like separated as a liquid and is collected as discharged liquid.

The collected exhaust gas is carbon dioxide and the like, and can be reused. In the same way, the collected discharged liquid can also be reused.

Also, a heating means 46 that heats the processing fluid introduced into the processing chamber 14 to keep the processing fluid at a predetermined temperature is provided on a side wall 16a of the chamber 16.

The heating means 46 is constructed of a heating medium such as heating wire, and there is provided a temperature control apparatus 48 that controls the power supplied to the heating wire from a power source (not shown) provided on the outside of the processing chamber 14 so as to keep the temperature of the heating means 46 at a predetermined temperature.

The cleaning/drying apparatus 10 is a batch-type apparatus that cleanes a plurality of substrates W. A single wafer processing cleaning/drying apparatus has fundamentally the same construction and processing flow as the cleaning/drying apparatus 10, and while a smaller processing chamber is sufficient, there is a reduction in the throughput.

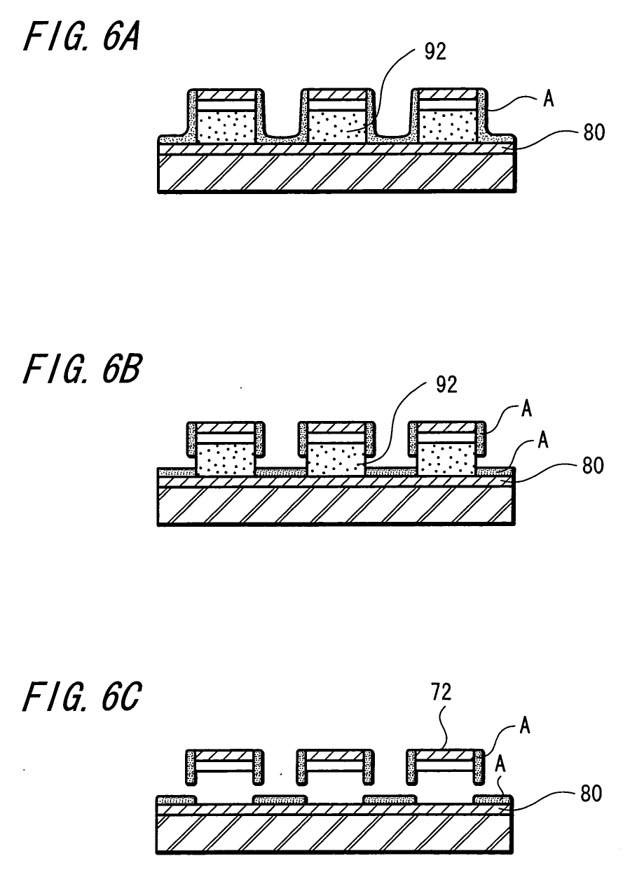

Next, the method of cleaning and drying the substrates according to the present embodiment will be described for the case where the cleaning/drying apparatus 10 described above is used. In the present embodiment, the substrates to be cleaned and dried are the micromachines shown in FIG. 6C and described earlier in a state where the sacrificial layer has been etched. Supercritical carbon dioxide is used as the supercritical fluid.

First, the substrate holding cassette 28 holding a plurality of the micromachines W is placed into the processing chamber 14 from the opening 12 of the processing chamber 14. Next, the cap 18 is closed and the processing chamber 14 is tightly closed.

After this, the pressure and temperature are regulated by the pressure/temperature controlling means 30 and carbon dioxide is introduced into the processing chamber 14 from the fluid supplying source 20.

In this state, first, according to regulation by the pressure/temperature controlling means 30, carbon dioxide in a gaseous state is introduced from the fluid supplying source 20 into the processing chamber 14 as a supercritical substance.

To prevent the introduced carbon dioxide from becoming a liquid inside the processing chamber 14, that is, to convert the carbon dioxide directly from a gas into supercritical carbon dioxide, the pressure and temperature of the carbon dioxide introduced into the processing chamber 14 are regulated by the pressure/temperature controlling means 30 and the temperature inside the processing chamber 14 is adjusted by the heating means 46 and the temperature control apparatus 48.

By doing so, the micromachines W formed with the fine structures are not exposed to gas-liquid interfaces, and the processing chamber 14 can be filled with supercritical fluid.

To do so, the carbon dioxide supplied in a gaseous state from the fluid supplying source 20 is introduced into the processing chamber 14, which is at normal pressure in the initial state, in a state where the carbon dioxide has been heated to the critical temperature or above by regulation by the pressure/temperature controlling means 30. Additionally, the temperature inside the processing chamber 14 is kept at the critical temperature of the supercritical substance or above by the heating means 46 and the temperature control apparatus 48.

As described above, in a state where the temperature inside the processing chamber 14 has been adjusted by the heating means 46 and the temperature control apparatus 48, carbon dioxide is continuously supplied to the processing chamber 14, so that the pressure inside the processing chamber 14 rises to the critical pressure of the supercritical substance or above, resulting in the carbon dioxide becoming supercritical carbon dioxide. For example, when carbon dioxide is used as the supercritical substance, the pressure is raised to at least 38 Mpa, the critical pressure of carbon dioxide, and the temperature is raised to at least 31.1° C., the critical temperature of carbon dioxide, so that the carbon dioxide becomes supercritical carbon dioxide.

Next, by adjusting the flow regulating valve 36 with respect to the carbon dioxide supplied into the processing chamber 14, a tertiary amine compound is supplied from the tertiary amine compound supplying source 22 and is added as a dissolution auxiliary agent.

It should be noted in a case where the tertiary amine compound is evenly dissolved at arbitrary temperature and pressure conditions at or above the critical point, the total added amount of the tertiary amine compound relative to the carbon dioxide is a concentration of 0.1 mol % or above in the supercritical carbon dioxide. When the concentration of the tertiary amine compound is below this concentration, it is difficult to remove etching residue that has been polymerized.

Also, the tertiary amine compound normally has a critical temperature and a critical pressure that are higher than those of carbon dioxide. Accordingly, since the critical temperature and critical pressure of a mixed fluid of carbon dioxide and the tertiary amine compound are a higher than the critical temperature and critical pressure of carbon dioxide alone, it is preferable for the temperature and pressure of the supercritical carbon dioxide to be respectively kept at 40° C. or above and lOMPa or above, which are higher than the critical pressure and critical temperature of carbon dioxide, so that the tertiary amine compound favorably dissolves in the carbon dioxide.

By doing so, supercritical carbon dioxide to which the tertiary amine compound has been added is supplied into the processing chamber 14. Also, by continuously supplying the supercritical carbon dioxide, it is possible to fill the inside of the processing chamber 14 with the supercritical carbon dioxide and when the internal pressure of the processing chamber 14 reaches a predetermined pressure or higher, the discharge valve 42 opens so that the pressure inside the processing chamber 14 is kept at a predetermined pressure. At this time, gas inside the processing chamber 14, for example, air, is completely replaced with the supercritical carbon dioxide.

In this way, in a state where the inside of the processing chamber 14 has been completely replaced with the supercritical carbon dioxide, a cleaning process that immerses the micromachines W in the supercritical carbon dioxide is carried out for a predetermined time. By doing so, fine particles such as etching residue and the like that adhere to the micromachines W are removed.

The fine particles removed from the micromachines W are discharged out of the processing chamber 14 together with the supercritical carbon dioxide from the fluid discharge port 40 via the discharge valve 42 and the discharged liquid separating apparatus 44.

When the above cleaning process has been completed and the fine particles of etching residue and the like have been removed from the micromachines W, the supplying of the tertiary amine compound from the tertiary amine compound supplying source 22 is stopped and only supercritical carbon dioxide is supplied into the processing chamber 14 so that the supercritical carbon dioxide to which the tertiary amine compound has been added is replaced with pure supercritical carbon dioxide. By doing so, the micromachines can be rinsed.

Next, the supplying of the carbon dioxide from the fluid supplying source 20 is stopped and the supercritical carbon dioxide inside the processing chamber 14 is discharged from the fluid discharge port 40 so that the temperature and pressure inside the processing chamber 14 fall, and the carbon dioxide inside the processing chamber 14 is gasified. By doing so, the carbon dioxide gas filling the inside of the processing chamber 14 dries the micromachines W held in the processing chamber 14, that is, supercritical drying can be carried out.

It should be noted that during the supercritical drying, the temperature and the pressure inside the processing chamber 14 are reduced so that the carbon dioxide in the state of a supercritical fluid inside the processing chamber 14 does not change to a liquid, that is, so that the supercritical carbon dioxide changes directly into a gas.

By doing so, the inside of the processing chamber 14 can be filled with gas without exposing the micromachines W formed with fine structures to gas-liquid interfaces.

To do so, when carbon dioxide is used as the supercritical fluid, the temperature inside the processing chamber 14 is kept at 31.1° C. or above which is equal to or above the supercritical state of 31.1° C. or above and 7.38 Mpa or above, and the pressure inside the processing chamber 14 is reduced to atmospheric pressure, so that the supercritical carbon dioxide inside the processing chamber 14 can be converted from a supercritical fluid to a gas.

After this, the temperature inside the processing chamber 14 is reduced from 31.1° C. or above to 20° C., for example. By doing so, the carbon dioxide inside the processing chamber 14 is directly changed from a supercritical fluid into a gas without becoming a liquid, so that the inside of the processing chamber 14 is placed in a drying state.

It should be noted that when a supercritical substance aside from carbon dioxide is used as the supercritical fluid, the same principles are applied as for carbon dioxide, and cleaning and rinsing should be performed at a suitable pressure and temperature for the substance being used.

In the above drying process, the carbon dioxide inside the processing chamber 14 that has been discharged from the fluid discharge port 40 is discharged to outside the system via the discharge valve 42 and the discharged liquid separating apparatus 44.

The carbon dioxide is discharged as a gas and is collected as exhaust gas. On the other hand, substances that accompany the carbon dioxide, for example, the tertiary amine compound used as the dissolution auxiliary agent and the etching residue, are separated as liquids by restoring the substances to atmospheric pressure, and are collected as discharged liquids. The discharged liquids and exhaust gas can be restored to a usable condition and reused.

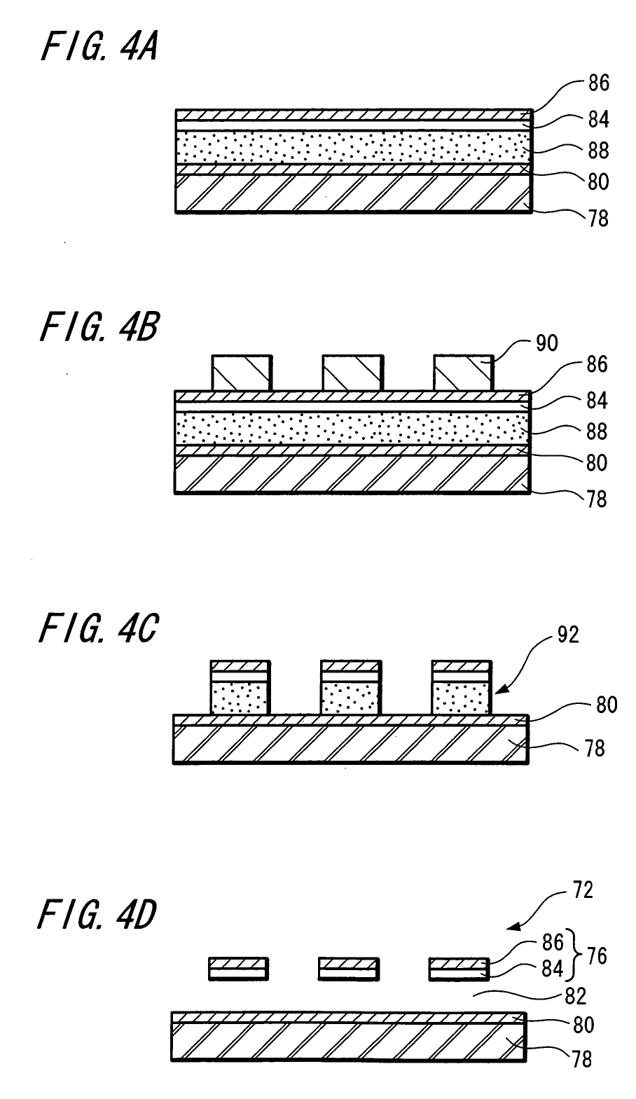

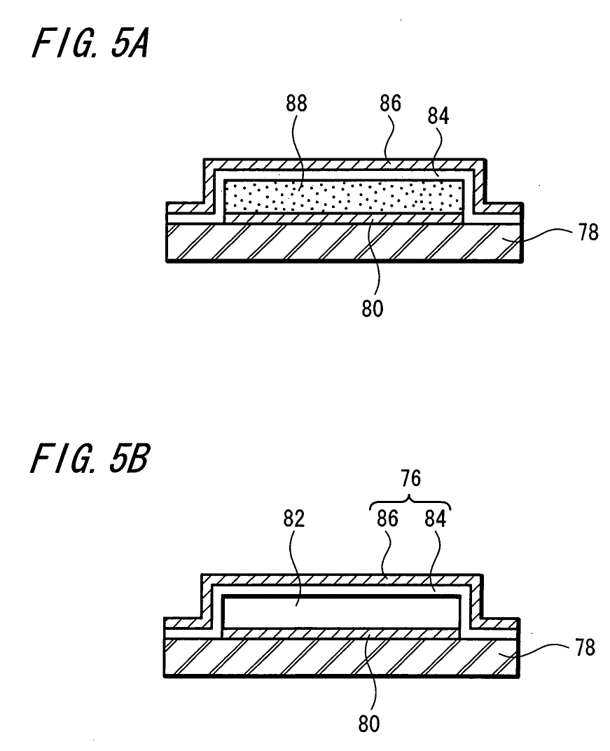

By carrying out a cleaning process using supercritical carbon dioxide and a drying process according to the above steps, as shown in FIGS. 4D and 5B, it is possible to completely remove residue adhering as shown in FIG. 4C to the surfaces of the micromachines W with gaps.

According to the method of the present embodiment, by adding, as a dissolution auxiliary agent, a tertiary amine compound to supercritical carbon dioxide that has superior permeability, it is possible to supply the tertiary amine compound together with the supercritical carbon dioxide into gaps in the fine structures of the micromachines.

The tertiary amine compound has a high cleaning performance and so is capable of dissolving and removing resist material and polymerized etching residue after etching (hereinafter simply “residue”), so that the cleaning performance of the supercritical carbon dioxide for the fine structures can be improved.

In addition, supercritical carbon dioxide has a higher density than carbon dioxide gas, so that with supercritical carbon dioxide, removed residue can easily be cleaned and remove together with the supercritical carbon dioxide from gaps in the fine structures. Accordingly, it is possible to reliably remove residue present in the gaps of fine structures without performing a wet-type cleaning after cleaning with a supercritical substance as in the related art.

In addition, a supercritical substance is used in place of a liquid such as a conventional cleaning liquid, and by adjusting the temperature and pressure inside the processing chamber 14, it is possible to convert the state from a gas to a supercritical fluid and from a supercritical fluid to a gas, and by not exposing the micromachines in which the fine structures are formed to gas-liquid interfaces, it is possible to prevent the micromachines from being destroyed by surface tension at gas-liquid interfaces. By doing so, it is possible to improve the manufacturing yield of micromachines.

Also according to the present embodiment, the cleaning process and drying process are performed together, so that compared to a conventional method where supercritical drying is carried out after a wet-type process, the number of processing steps in the cleaning process can be reduced.

In the present embodiment, a method of manufacturing fine movable elements called micromachines W is described as an embodiment of the method according to the present invention, but the method of the present invention is not limited to being applied to a cleaning process in a manufacturing process for this kind of micromachine and can be widely applied to a cleaning process for any substrate with a fine structure, with the same effects being obtained.

For example, in a following second embodiment, during the manufacturing of a semiconductor device with a large scale integrated circuit, the present invention can be applied in the same way to cleaning of a wafer on which high-aspect ratio pattern structures including electrodes, wiring patterns, resist patterns, and the like are formed, and to a cleaning process for a mask in which a high-aspect ratio pattern is formed when forming a mask for electron beam lithography and X-ray lithography that is required to form such patterns.

### Second Exemplified Embodiment

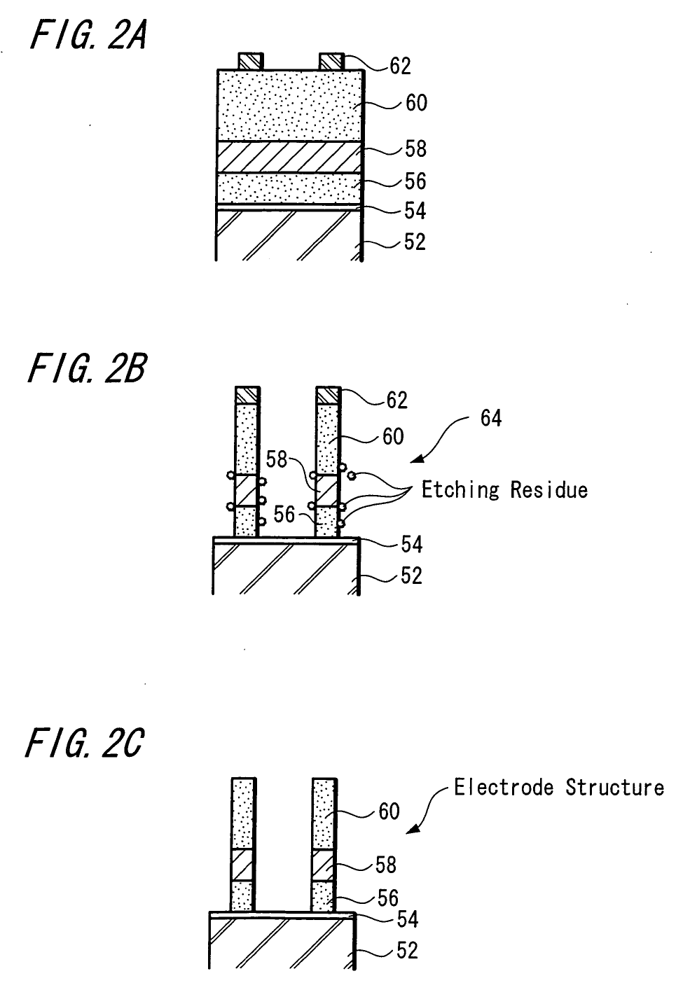

In the first embodiment, micromachines are described as an example, but as mentioned above, the method of the present invention can be applied to other substrates. In the present embodiment, the cleaning method according to the present invention is applied to cleaning electrode structures with a high-aspect ratio that are shown in FIGS. 2A to 2C. These drawings are respectively cross-sectional views of the respective processes when forming the electrode structures.

In the present embodiment, first, as shown in FIG. 2A, a thin insulating film is formed as a first layer 54 on a substrate 52 made of single-crystal silicon. After this, a second layer (insulating film) 56, a third layer (metal film) 58, and a fourth layer (insulating layer) 60 are successively formed to produce a laminated structure.

A resist film is applied onto the fourth layer 60 and photolithography is carried out to form a resist mask 62.

After this, dry etching is performed from above the resist mask to etch the fourth layer 60, the third layer 58, and the second layer 56, and as shown in FIG. 2B, an electrode structure 64 with a fine pattern composed of the third layer (metal film) 58 is formed on the first layer 54 of the silicon substrate 52.

However, as shown in FIG. 2B, etching residue is produced on the second layer 54 and the side walls of the third layer 58, and therefore needs to be removed.

For this reason, the cleaning/drying apparatus 10 is used in the same way as in the first embodiment in which the example of micromachines is described, and by adding a tertiary amine compound to a supercritical fluid, for example, supercritical carbon dioxide, and carrying out a cleaning process for the electrode structure 64, as shown in FIG. 2C, a fine electrode structure 64 can be formed from which the etching residue has been removed, as shown in FIG. 2C, without the fine structure being destroyed.

It should be noted that in the first and second embodiments, examples where supercritical carbon dioxide is used as the supercritical fluid and a tertiary amine compound is added as a dissolution auxiliary agent are described, although aside from the dissolution auxiliary agent, it is also effective to add an anti-corrosion agent to present corrosion of component materials, such as metal used as wiring, in the fine structure as necessary.

When applying the method of the present invention, in a case where a supercritical substance aside from carbon dioxide is used as the supercritical fluid, the cleaning process and the drying process are carried out with conditions, such as temperature, pressure, and added amount of dissolution auxiliary agent, being set as appropriate for the supercritical substance.

As described above, according to the first method of the present invention, by adding a tertiary amine compound, out of the organic amine compounds, to a supercritical fluid, it is possible to reliably clean away and remove foreign matter such as etching residue present in gaps in a fine structure of a substrate and to dry the substrate without the organic amine compound reacting with the supercritical fluid and hardening as in the related art.

Also, according to the second method of the present invention, by applying the first method using a single tank-type cleaning/drying apparatus, it is possible to carry out a cleaning process and a drying process together, thereby reducing the number of processing steps and improving the productivity of the cleaning/drying process that cleanes and dries a substrate with a fine structure using a supercritical fluid.

By applying the first and second methods of the present invention, it is possible to maintain the quality of substrates having a fine structure such as semiconductor devices and micromachines, to increase the yield, and to reduce the manufacturing cost.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A method of cleaning a substrate having a fine structure using a supercritical fluid, comprising:
a cleaning step that uses a supercritical fluid to which a predetermined amount of a tertiary amine compound has been added as a cleaning liquid and cleanes the substrate by having the substrate contact the supercritical fluid to which the tertiary amine compound has been added.

2. A method of cleaning according to claim 1, wherein a substance that is in a gaseous state at ordinary temperature and normal pressure is subjected to a phase change to convert the substance into a supercritical fluid which is used as the cleaning liquid, the substrate is made to contact with the substance in a gaseous state, and then a phase change is effected to convert the substance in a gaseous state contacting the substrate directly into a supercritical fluid without passing a liquid state.

3. A method of cleaning according to either claim 1 or claim 2, further comprising, following the cleaning step, a drying step of drying the substrate by directly gasifying the supercritical fluid in contact with the substrate without liquefying the supercritical fluid.

4. A method of cleaning according to either claim 1 or claim 2, further comprising, following the cleaning step, a rinsing step of rinsing the substrate by supplying only the supercritical fluid and a drying step of subsequently drying the substrate by directly gasifying the supercritical fluid in contact with the substrate without liquefying the supercritical fluid.

5. A method of cleaning a substrate having a fine structure using a supercritical fluid, comprising:
a cleaning step of cleaning the substrate using a single tank-type cleaning/drying apparatus having a single tank cleaning/drying chamber by supplying the supercritical fluid, to which a predetermined amount of tertiary amine compound has been added, to the cleaning/drying chamber in which the substrate is held;
a rinsing step of subsequently rinsing the substrate while replacing the supercritical fluid to which the tertiary amine compound has been added by supplying only the supercritical fluid to the cleaning/drying chamber; and
a drying step of subsequently drying the substrate by removing the supercritical fluid in contact with the substrate by directly gasifying the supercritical fluid without liquefying the supercritical fluid,
wherein the cleaning step and the drying step are carried out successively in the single tank cleaning/drying chamber.

6. A method of cleaning according to claim 5, wherein in the cleaning step, when a substance that is in a gaseous state at ordinary temperature and normal pressure is subjected to a phase change to convert the substance into a supercritical fluid which is used as the cleaning liquid, the substance is introduced into the cleaning/drying chamber in a gaseous state, a phase change is effected so that the substance in the gaseous state is converted directly into a supercritical fluid, and then the predetermined amount of the tertiary amine compound is supplied and added.

7. A method of cleaning according to any of claim 1 to claim 6, wherein supercritical carbon dioxide is used as the supercritical fluid.

8. A method of cleaning according to any of claim 1 to claim 7, wherein the tertiary amine compound is an aliphatic amine having at least one substituent group selected from an alkyl group, a hydroxyalkyl group, and an alkoxyalkyl group.

9. A method of cleaning according to any of claim 1 to claim 7, wherein the tertiary amine compound is an aromatic amine having at least one substituent group selected from an aryl group and an aralkyl group.

10. A method of cleaning according to any of claim 1 to claim 7, wherein the tertiary amine compound is a heterocyclic amine.
